(19) United States
(12) Patent Application Publication
(10) Pub. No.: US 2025/0385305 A1
(43) Pub. Date: Dec. 18, 2025

(54) SULFIDE-BASED SOLID ELECTROLYTE AND METHOD FOR PREPARING SAME

(71) Applicant: INDUSTRY-UNIVERSITY COOPERATION FOUNDATION HANYANG UNIVERSITY ERICA CAMPUS, Ansan-si (KR)

(72) Inventors: Tae Joo PARK, Ansan-si (KR); Min Ji LEE, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 19/316,341

(22) Filed: Sep. 2, 2025

Related U.S. Application Data
(63) Continuation of application No. PCT/KR2024/002751, filed on Mar. 4, 2024.

(30) Foreign Application Priority Data
Mar. 3, 2023 (KR) 10-2023-0028337
Mar. 4, 2024 (KR) 10-2024-0030592

(51) Int. Cl. H01M 10/0562; H01M 10/058

(52) U.S. Cl. CPC H01M 10/0562; H01M 10/058; H01M 2300/002; H01M 2300/0094

(57) ABSTRACT

Provided is a method for preparing a sulfide-based solid electrolyte. The method for preparing a sulfide-based solid electrolyte may comprise the steps of: preparing a solid electrolyte including sulfide; and providing a precursor and a reactant containing oxygen on the solid electrolyte to form a protective film on the solid electrolyte through a reaction between the precursor and the reactant.

### CROSS-REFERENCE TO RELATED APPLICATIONS

This is a continuation of International Patent Application PCT/KR2024/002751 (filed 4 Mar. 2024), which claims the benefit of Republic of Korea Patent Application 10-2023-0028337 (filed 3 Mar. 2023) and Republic of Korea Patent Application 10-2024-0030592 (filed 4 Mar. 2024). Each of these priority applications is hereby incorporated herein by reference in its entirety.

### TECHNICAL FIELD

The present invention relates to a sulfide-based solid electrolyte and a method for preparing the same, and more particularly, to stabilization of a sulfide-based solid electrolyte by forming a protective film on the sulfide-based solid electrolyte.

### BACKGROUND ART

An all-solid-state battery is one of the most spotlighted next-generation batteries since a liquid electrolyte is replaced with a solid electrolyte so as to provide a high output, a high capacity, and high stability. A sulfide-based solid electrolyte has higher ionic conductivity than oxide or a polymer, and is advantageous for forming a contact interface between an electrode and an electrolyte due to soft viscosity. However, the sulfide-based solid electrolyte is sensitive to moisture and has weak stability in atmosphere, so that it is not easy to store and handle the sulfide-based solid electrolyte, and thus there are difficulties in industrialization. In addition, an interfacial side reaction with a positive electrode active material due to high reactivity may cause deterioration of battery performance. Since surface stabilization is essential to solve the problems described above, various studies thereon are being conducted.

For example, Republic of Korea Unexamined Patent Publication 10-2021-0065147 (published 3 Jun. 2021) discloses stabilization of a sulfide-based solid electrolyte through a fluorine-based polymer protective film covering. However, the technology described above uses a chemical wet scheme for the protective film covering, and such a wet coating scheme has significantly low coating efficiency due to vulnerability of the sulfide-based solid electrolyte to moisture.

Therefore, the present invention provides a method for stabilizing a sulfide-based solid electrolyte by covering the sulfide-based solid electrolyte with a protective film by a dry scheme.

### DISCLOSURE

### Technical Problem

One technical object of the present invention is to provide a sulfide-based solid electrolyte and a method for preparing the same.

Another technical object of the present invention is to provide a method for stabilizing a sulfide-based solid electrolyte.

Still another technical object of the present invention is to provide a sulfide-based solid electrolyte in which reactivity with moisture is reduced and a method for preparing the same.

Yet another technical object of the present invention is to provide a sulfide-based solid electrolyte in which an amount of hydrogen sulfide generation caused by exposure to atmosphere is reduced and a method for preparing the same.

Technical objects of the present invention are not limited to the technical objects described above.

### Technical Solution

To achieve the technical objects described above, the present invention provides a method for preparing a sulfide-based solid electrolyte.

According to one embodiment, the method for preparing the sulfide-based solid electrolyte includes: preparing a solid electrolyte including sulfide; and forming a protective film, which is obtained by reacting a precursor and a reactant, on the solid electrolyte by providing the precursor and the reactant including oxygen on the solid electrolyte.

According to one embodiment, the forming of the protective film may include: a precursor provision step of providing the precursor on the solid electrolyte; a first dwell step of reacting the precursor with a surface of the solid electrolyte; a reactant provision step of providing the reactant on the solid electrolyte to which the precursor is provided; and a second dwell step of reacting the reactant with the surface of the solid electrolyte to which the precursor is provided.

According to one embodiment, the forming of the protective film may be performed in a reactor that rotates, in which the rotation of the reactor may be stopped while the precursor provision step, the first dwell step, the reactant provision step, and the second dwell step are performed, and the rotation of the reactor may be performed after the precursor provision step, the first dwell step, the reactant provision step, and the second dwell step are performed.

According to one embodiment, the precursor may include one of aluminum (Al), zirconium (Zr), niobium (Nb), titanium (Ti), zinc (Zn), and lithium (Li).

According to one embodiment, the reactant may include ozone (O₃).

According to one embodiment, the forming of the protective film may include forming a first protective film and forming a second protective film, in which the forming of the first protective film may include: a first precursor provision step of providing a first precursor on the solid electrolyte; and a first reactant provision step of providing a first reactant on the solid electrolyte to which the first precursor is provided, and the forming of the second protective film may include: a second precursor provision step of providing a second precursor on the solid electrolyte; and a second reactant provision step of providing a second reactant on the solid electrolyte to which the second precursor is provided.

According to one embodiment, the first precursor and the first reactant may react with each other so that the first protective film is formed on the solid electrolyte, and the second precursor and the second reactant may react with each other so that the second protective film is formed on the first protective film.

According to one embodiment, the first precursor provision step and the first reactant provision step may be defined as a first unit process, and the second precursor provision step and the second reactant provision step may be defined as a second unit process, in which each of the first unit process and the second unit process may be repeatedly performed a plurality of times.

According to one embodiment, the first precursor and the second precursor may include different metals.

According to one embodiment, the solid electrolyte may have a powder form.

To achieve the technical objects described above, the present invention provides a sulfide-based solid electrolyte.

According to one embodiment, the sulfide-based solid electrolyte includes: a core; and a shell surrounding the core, wherein the core includes sulfide, and the shell includes a metal oxide.

According to one embodiment, the metal oxide may include one of aluminum oxide (Al₂O₃), zirconium oxide (ZrO₂), niobium oxide (NbOₓ, x>0), titanium oxide (TiO₂), zinc oxide (ZnO), LiAlOₓ (x>0), LiZrOₓ (x>0), LiNbOₓ (x>0), and LiTiOₓ (x>0).

According to one embodiment, the shell may include a first protective film including a first metal oxide and a second protective film including a second metal oxide, in which the first protective film may surround the core, and the second protective film may surround the first protective film.

According to one embodiment, the first metal oxide and the second metal oxide may be different from each other.

### Advantageous Effects

According to the present invention, a protective film including a metal oxide may be formed on a sulfide-based solid electrolyte by an atomic layer deposition scheme, so that the sulfide-based solid electrolyte can be stabilized. Accordingly, hydrogen sulfide generation caused by exposure to atmosphere can be significantly reduced while maintaining an inherent resistance and inherent ionic conductivity of the sulfide-based solid electrolyte.

### DESCRIPTION OF DRAWINGS

FIG. 1 is a flowchart for describing a method for preparing a sulfide-based solid electrolyte according to a first embodiment of the present invention.

FIGS. 2 and 3 are views for specifically describing a step S120 of the method for preparing the sulfide-based solid electrolyte according to the first embodiment of the present invention.

FIG. 4 is a view for describing the sulfide-based solid electrolyte according to the first embodiment of the present invention.

FIG. 5 is a flowchart for describing a method for preparing a sulfide-based solid electrolyte according to a second embodiment of the present invention.

FIGS. 6 and 7 are views for specifically describing a step S220 of the method for preparing the sulfide-based solid electrolyte according to the second embodiment of the present invention.

FIGS. 8 and 9 are views for specifically describing a step S230 of the method for preparing the sulfide-based solid electrolyte according to the second embodiment of the present invention.

FIG. 10 is a view for describing the sulfide-based solid electrolyte according to the second embodiment of the present invention.

FIG. 11 provides photographs of Samples 1-1 to 1-3.

FIG. 12 is a view for describing aluminum content analysis results of Samples 2-1 to 2-4.

FIG. 13 is a view for comparing hydrogen sulfide generation amounts of Samples 3-1 to 3-3 exposed to an atmospheric environment.

FIGS. 14 and 15 are views showing EIS analysis results of Samples 3-1 to 3-3.

FIG. 16 is a view for comparing hydrogen sulfide generation amounts of Samples 4-1 and 4-2 exposed to an atmospheric environment.

FIG. 17 is a view showing EIS analysis results of Samples 4-1 and 4-2.

### DETAILED DESCRIPTION

Hereinafter, exemplary embodiments of the present invention will be described in detail with reference to the accompanying drawings. However, the technical idea of the present invention is not limited to the embodiments described herein, but may be embodied in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, thicknesses of films and regions are exaggerated for effective description of the technical contents.

In addition, although the terms such as first, second, and third have been used to describe various elements in various embodiments of the present disclosure, the elements are not limited by the terms. The terms are used only to distinguish one element from another element. Therefore, an element mentioned as a first element in one embodiment may be mentioned as a second element in another embodiment. The embodiments described and illustrated herein include their complementary embodiments, respectively. Further, the term “and/or” used in the present disclosure is used to include at least one of the elements enumerated before and after the term.

As used herein, an expression in a singular form includes a meaning of a plural form unless the context clearly indicates otherwise. Further, the terms such as “including” and “having” are intended to designate the presence of features, numbers, steps, elements, or combinations thereof described herein, and shall not be construed to preclude any possibility of the presence or addition of one or more other features, numbers, steps, elements, or combinations thereof. In addition, the term “connection” used herein is used to include both indirect and direct connections of a plurality of elements.

Further, in the following description of the present invention, detailed descriptions of known functions or configurations incorporated herein will be omitted when they may make the gist of the present invention unnecessarily unclear.

### Sulfide-Based Solid Electrolyte and Method for Preparing Same according to First Embodiment

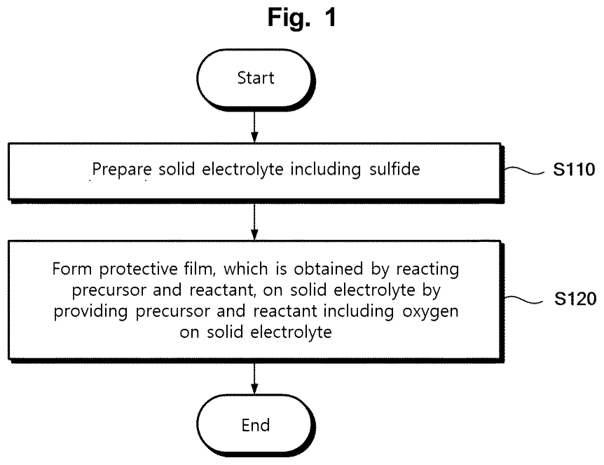

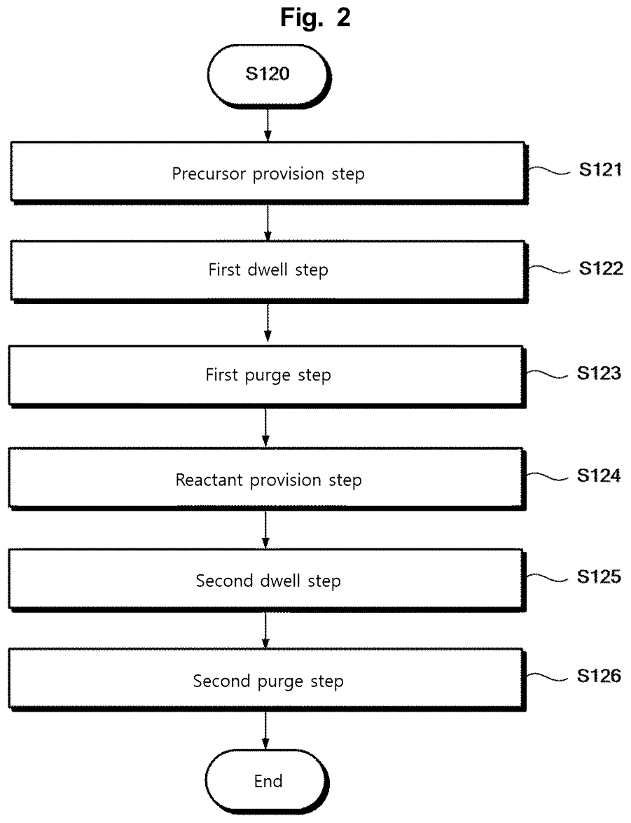

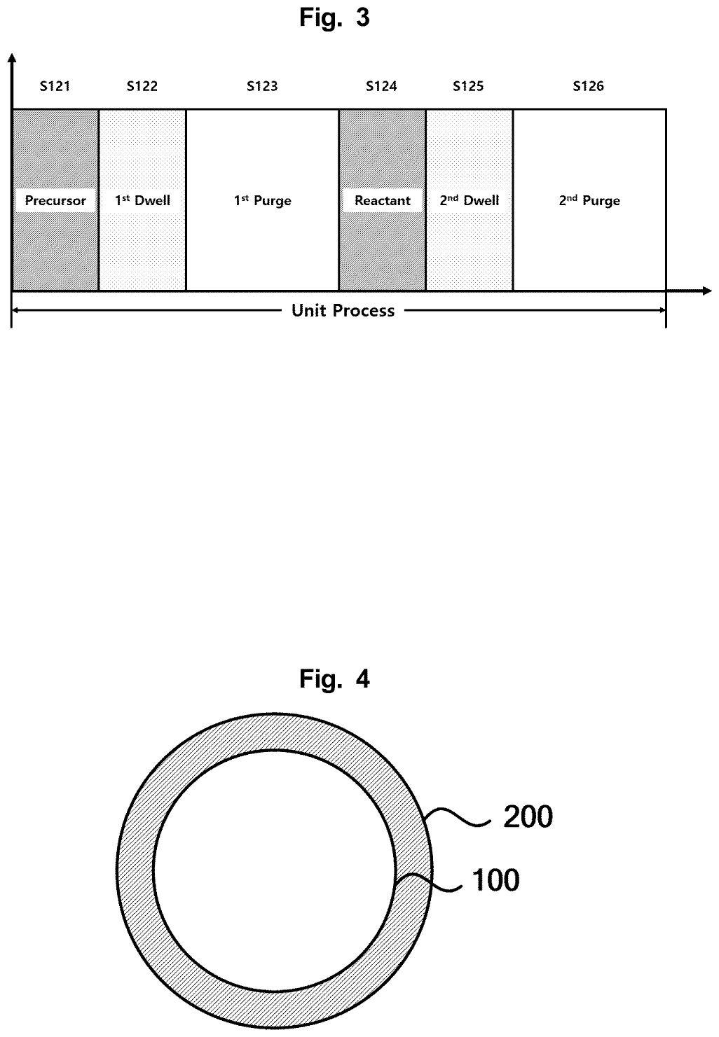

FIG. 1 is a flowchart for describing a method for preparing a sulfide-based solid electrolyte according to a first embodiment of the present invention, FIGS. 2 and 3 are views for specifically describing a step S120 of the method for preparing the sulfide-based solid electrolyte according to the first embodiment of the present invention, and FIG. 4 is a view for describing the sulfide-based solid electrolyte according to the first embodiment of the present invention.

Referring to FIGS. 1 to 4, a solid electrolyte 100 including sulfide may be prepared (S110). According to one embodiment, the solid electrolyte 100 may be solid particles including a sulfur component, and may include a material that may be used as a solid electrolyte. In addition, the solid electrolyte 100 may have a powder form in which solid particles including a sulfur component are gathered. For example, the solid electrolyte 100 may include one of Li₂S—SiS₂, Li₂S—P₂S₅, Li₂S—GeS₂, Li₂S—B₂S₃, Li₂S—Ga₂S₃, Li₂S—Al₂S₃, Li₂S—GeS₂—P₂S₅, Li₂S—Al₂S₃—P₂S₅, Li₂S—P₂S₃, Li₂S—P₂S₃—P₂S₅, LiX—Li₂S—P₂S₅, LiX—Li₂S—SiS₂, LiX—Li₂S—B₂S₃, Li₃PO₄—Li₂S—Si₂S, Li₃PO₄—Li₂S—SiS₂, LiPO₄—Li₂S—SiS, LiX—Li₂S—P₂O₅, LiX—Li₃PO₄—P₂S₅, and Li_{6-y}—PS_{5-y}—Cl_{1+y} (X: one of I, Br, and Cl, 0≤y≤5).

A protective film 200, which is obtained by reacting a precursor and a reactant, may be formed on the solid electrolyte 100 by providing the precursor and the reactant including oxygen on the solid electrolyte 100 (S120). Accordingly, the sulfide-based solid electrolyte according to the first embodiment may be prepared. The sulfide-based solid electrolyte according to the first embodiment may have a core-shell structure.

According to one embodiment, the protective film 200 may be formed by an atomic layer deposition (ALD) scheme using the precursor and the reactant.

In more detail, the step of forming the protective film 200 may include: a precursor provision step S121 (Precursor) of providing the precursor on the solid electrolyte 100; a first dwell step S122 (1st Dwell) of reacting the precursor with a surface of the solid electrolyte; a first purge step S123 (1st Purge) of removing materials remaining around the solid electrolyte reacted with the precursor; a reactant provision step S124 (Reactant) of providing the reactant on the solid electrolyte to which the precursor is provided; a second dwell step S125 (2nd Dwell) of reacting the reactant with the surface of the solid electrolyte to which the precursor is provided; and a second purge step S126 (2nd Purge) of removing materials remaining around the solid electrolyte reacted with the reactant. For example, the precursor may include one of aluminum (Al), zirconium (Zr), niobium (Nb), titanium (Ti), zinc (Zn), and lithium (Li). For example, the reactant may include ozone (O₃). Accordingly, the protective film 200 may be formed in the form of a metal oxide including one of aluminum oxide (Al₂O₃), zirconium oxide (ZrO₂), niobium oxide (NbOₓ, x>0), titanium oxide (TiO₂), zinc oxide (ZnO), LiAlOₓ (x>0), LiZrOₓ (x>0), LiNbOₓ (x>0), and LiTiOₓ (x>0).

According to one embodiment, the steps S121 to S126 may be defined as a unit process, and the unit process may be repeatedly performed a plurality of times. According to the number of repetitions of the unit process, a thickness and various physical properties of the protective film 200 may be controlled.

According to one embodiment, the protective film 200 may have a thickness of less than 20 nm, a coverage (degree of coating on particles) of 50% or more, and a grain boundary of less than 50%. Accordingly, the protective film 200 may be easily broken by a pressurization process in a process of preparing an all-solid-state battery cell by using the sulfide-based solid electrolyte on which the protective film 200 is formed, so that a resistance enhancement problem caused by the sulfide-based solid electrolyte may be resolved. In contrast, when the protective film 200 has a thickness of 200 nm or more, a coverage of less than 50%, and a grain boundary of 50% or more, the protective film 200 may remain despite the pressurization process performed in the process of preparing the all-solid-state battery cell, and the remaining protective film 200 may act as a resistance at an interface between an electrode and an electrolyte, so that a performance deterioration problem of the all-solid-state battery cell may be caused.

According to one embodiment, the step S120 of forming the protective film 200 may be performed in a reactor that rotates, in which the rotation of the reactor may be stopped while the precursor provision step S121, the first dwell step S122, the first purge step S123, the reactant provision step S124, the second dwell step S125, and the second purge step S126 are performed, and the rotation of the reactor may be performed after the precursor provision step S121, the first dwell step S122, the first purge step S123, the reactant provision step S124, the second dwell step S125, and the second purge step S126 are performed. In other words, the rotation of the reactor may be stopped while the unit process (S121 to S126) is performed, and the rotation of the reactor may be performed after the unit process (S121 to S126) is performed.

In contrast, according to another embodiment, the rotation of the reactor may be stopped while the steps S121 to S126 are performed, in which the rotation of the reactor may be performed after the step S123 and after the step S126. In other words, the rotation of the reactor may be stopped during a precursor process (S121 to S123), and the rotation of the reactor may be performed at a time point where the precursor process (S121 to S123) is terminated. In addition, the rotation of the reactor may be stopped again during a reactant process (S124 to S126), and the rotation of the reactor may be performed at a time point where the reactant process (S124 to S126) is terminated.

As described above, the rotation of the reactor may be controlled, so that damage and deterioration of the solid electrolyte may be minimized, and deposition efficiency of the protective film 200 may be improved.

In more detail, when a material film is deposited on surfaces of solid particles having a powder form through an atomic layer deposition (ALD) scheme, an atomic layer deposition process may be performed within a rotation reactor to improve deposition uniformity of the material film, and the rotation of the reactor may be continuously performed while the precursor and the reactant are provided. However, unlike general solid particles, the sulfide-based solid electrolyte may have a relatively soft characteristic. Therefore, when the rotation of the reactor is continuously performed, the sulfide-based solid electrolyte may adhere to an inner side wall of the rotation reactor, so that deposition uniformity may deteriorate, and physical damage may be caused by the rotation.

Accordingly, according to the present invention, in order to solve the above-described problems (the deposition uniformity deterioration and the physical damage of the sulfide-based solid electrolyte caused by the rotation of the reactor), the rotation of the reactor may be controlled as described above. As a consequence, the damage to the solid electrolyte caused by the rotation may be minimized, and the deposition uniformity of the protective film 200 may be improved.

### Sulfide-Based Solid Electrolyte and Method for Preparing Same according to Second Embodiment

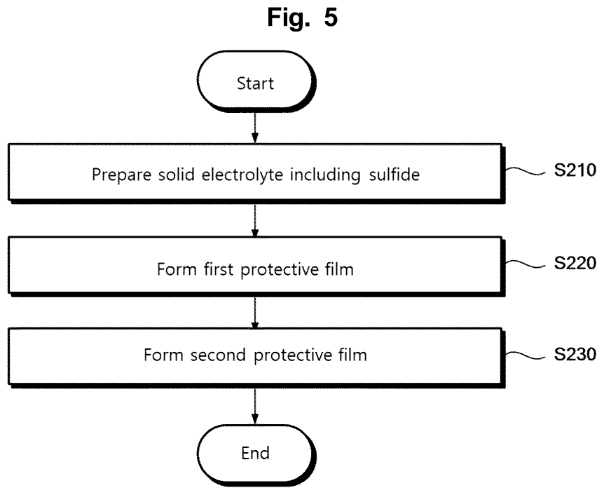

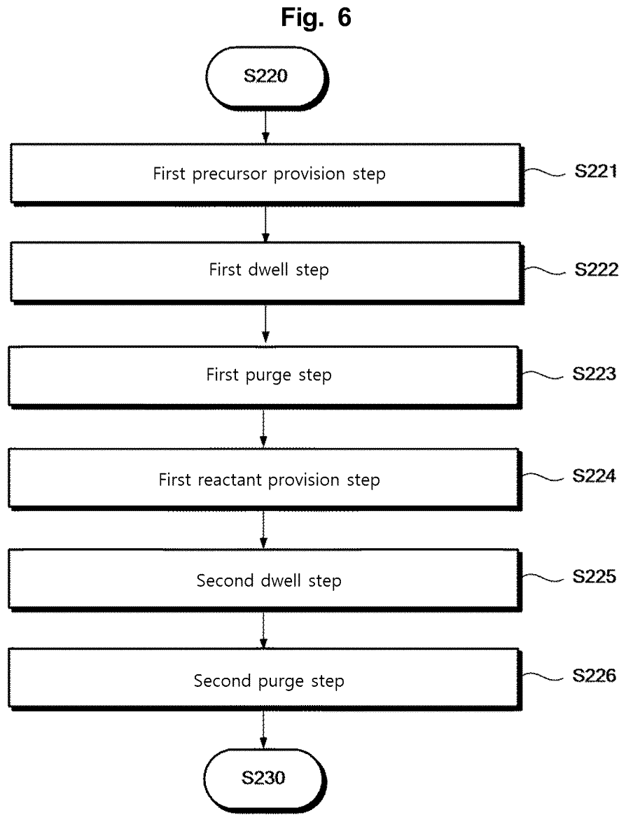

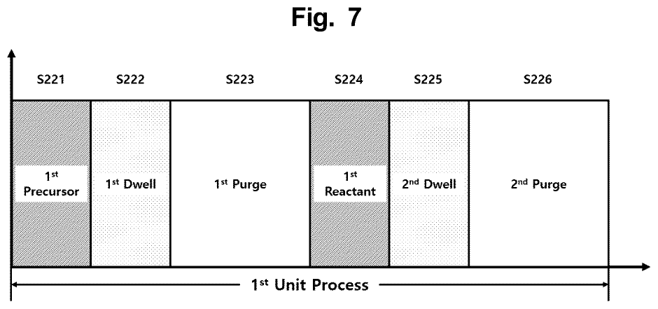

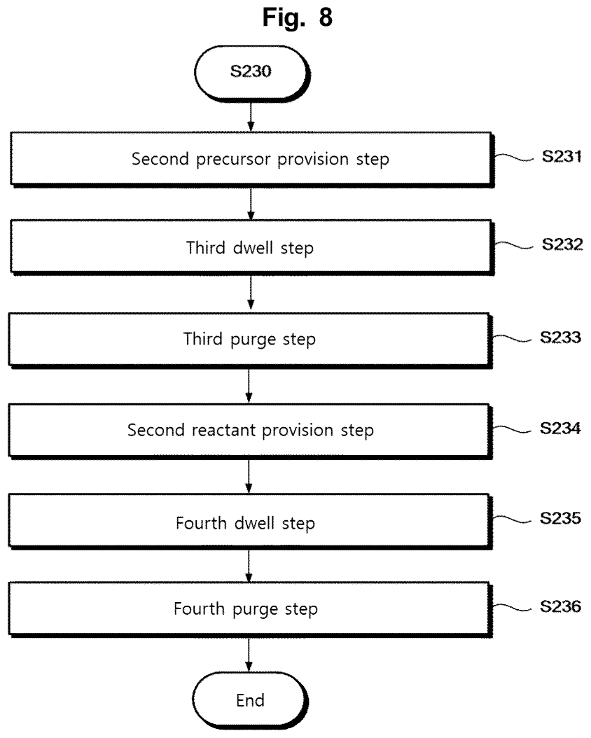

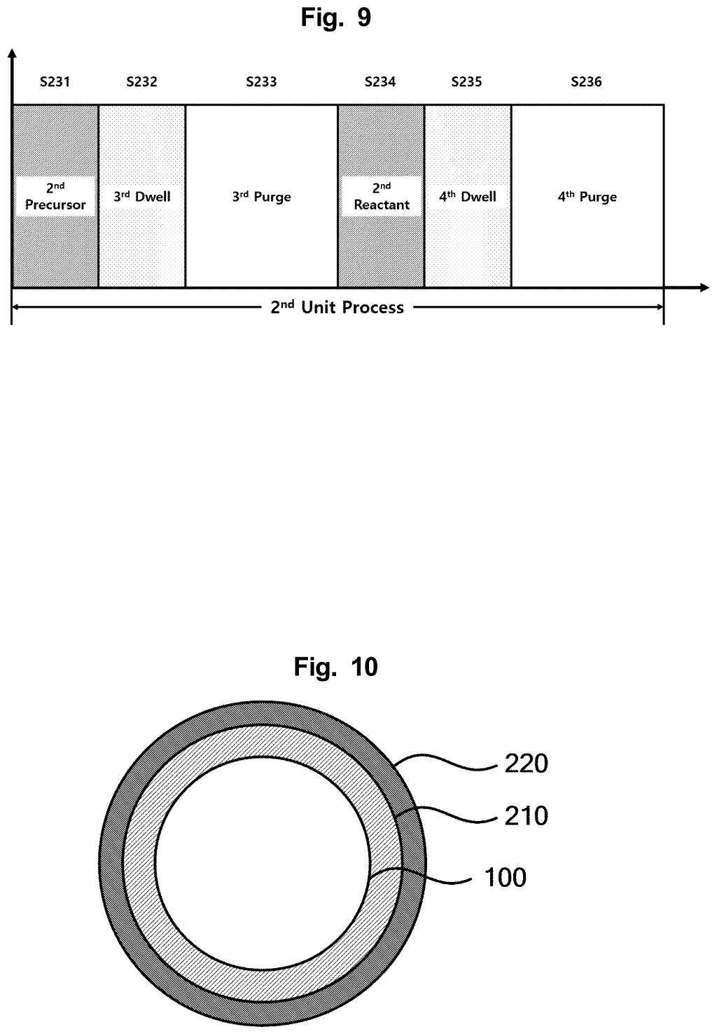

FIG. 5 is a flowchart for describing a method for preparing a sulfide-based solid electrolyte according to a second embodiment of the present invention, FIGS. 6 and 7 are views for specifically describing a step S220 of the method for preparing the sulfide-based solid electrolyte according to the second embodiment of the present invention, FIGS. 8 and 9 are views for specifically describing a step S230 of the method for preparing the sulfide-based solid electrolyte according to the second embodiment of the present invention, and FIG. 10 is a view for describing the sulfide-based solid electrolyte according to the second embodiment of the present invention.

Referring to FIGS. 5 to 10, a solid electrolyte 100 including sulfide may be prepared (S210). According to one embodiment, the solid electrolyte 100 may be solid particles including a sulfur component, and may include a material that may be used as a solid electrolyte. In addition, the solid electrolyte 100 may have a powder form in which solid particles including a sulfur component are gathered. For example, the solid electrolyte 100 may include one of Li₂S—SiS₂, Li₂S—P₂S₅, Li₂S—GeS₂, Li₂S—B₂S₃, Li₂S—Ga₂S₃, Li₂S—Al₂S₃, Li₂S—GeS₂—P₂S₅, Li₂S—Al₂S₃—P₂S₅, Li₂S—P₂S₃, Li₂S—P₂S₃—P₂S₅, LiX—Li₂S—P₂S₅, LiX—Li₂S—SiS₂, LiX—Li₂S—B₂S₃, Li₃PO₄—Li₂S—Si₂S, Li₃PO₄—Li₂S—SiS₂, LiPO₄—Li₂S—SiS, LiX—Li₂S—P₂O₅, and LiX—Li₃PO₄—P₂S₅ (X: one of I, Br, and Cl).

A first protective film 210, which is obtained by reacting a first precursor and a first reactant, may be formed on the solid electrolyte 100 by providing the first precursor and the first reactant on the solid electrolyte 100 (S220).

According to one embodiment, the first protective film 210 may be formed by an atomic layer deposition (ALD) scheme using the first precursor and the first reactant.

In more detail, the step S220 of forming the first protective film 210 may include: a first precursor provision step S221 (1st Precursor) of providing the first precursor on the solid electrolyte 100; a first dwell step S222 (1st Dwell) of reacting the first precursor with a surface of the solid electrolyte; a first purge step S223 (1st Purge) of removing materials remaining around the solid electrolyte reacted with the first precursor; a first reactant provision step S224 (1st Reactant) of providing the first reactant on the solid electrolyte to which the first precursor is provided; a second dwell step S225 (2nd Dwell) of reacting the first reactant with the surface of the solid electrolyte to which the first precursor is provided; and a second purge step S226 (2nd Purge) of removing materials remaining around the solid electrolyte reacted with the first reactant. For example, the first precursor may include one of aluminum (Al), zirconium (Zr), niobium (Nb), titanium (Ti), zinc (Zn), and lithium (Li). For example, the first reactant may include ozone (O₃). Accordingly, the first protective film 210 may be formed in the form of a metal oxide including one of aluminum oxide (Al₂O₃), zirconium oxide (ZrO₂), niobium oxide (NbOₓ, x>0), titanium oxide (TiO₂), zinc oxide (ZnO), LiAlOₓ (x>0), LiZrOₓ (x>0), LiNbOₓ (x>0), and LiTiOₓ (x>0).

According to one embodiment, the steps S221 to S226 may be defined as a first unit process, and the first unit process may be repeatedly performed a plurality of times. According to the number of repetitions of the first unit process, a thickness and various physical properties of the first protective film 210 may be controlled.

A second protective film 220, which is obtained by reacting a second precursor and a second reactant, may be formed on the first protective film 210 by providing the second precursor and the second reactant on the solid electrolyte 100 on which the first protective film 210 is formed (S230).

Accordingly, the sulfide-based solid electrolyte according to the second embodiment may be prepared. The sulfide-based solid electrolyte according to the second embodiment may have a core-shell structure, in which the shell may include the first protective film 210 and the second protective film 220.

According to one embodiment, the second protective film 220 may be formed by an atomic layer deposition (ALD) scheme using the second precursor and the second reactant.

In more detail, the step S230 of forming the second protective film 220 may include: a second precursor provision step S231 (2nd Precursor) of providing the second precursor on the solid electrolyte 100 on which the first protective film 210 is formed; a third dwell step S232 (3rd Dwell) of reacting the second precursor with a surface of the first protective film 210; a third purge step S233 (3rd Purge) of removing materials remaining around the first protective film 210 reacted with the second precursor; a second reactant provision step S234 (2nd Reactant) of providing the second reactant on the first protective film 210 to which the second precursor is provided; a fourth dwell step S235 (4th Dwell) of reacting the second reactant with the surface of the first protective film 210 to which the second precursor is provided; and a fourth purge step S236 (4th Purge) of removing materials remaining around the first protective film 210 reacted with the second reactant. For example, the second precursor may include one of aluminum (Al), zirconium (Zr), niobium (Nb), titanium (Ti), zinc (Zn), and lithium (Li). For example, the second reactant may include ozone (O₃). Accordingly, the second protective film 220 may be formed in the form of a metal oxide including one of aluminum oxide (Al₂O₃), zirconium oxide (ZrO₂), niobium oxide (NbOₓ, x>0), titanium oxide (TiO₂), zinc oxide (ZnO), LiAlOₓ (x>0), LiZrOₓ (x>0), LiNbOₓ (x>0), and LiTiOₓ (x>0).

According to one embodiment, the first precursor and the second precursor may include different metals. Accordingly, the first protective film 210 and the second protective film 220 may include different metal oxides.

According to one embodiment, the steps S231 to S236 may be defined as a second unit process, and the second unit process may be repeatedly performed a plurality of times. According to the number of repetitions of the second unit process, a thickness and various physical properties of the second protective film 220 may be controlled.

According to the method for preparing the sulfide-based solid electrolyte of the second embodiment, the rotation of the reactor may also be controlled, as described in the method for preparing the sulfide-based solid electrolyte according to the first embodiment.

### Sulfide-Based Solid Electrolyte and Method for Preparing Same according to Third Embodiment

A sulfide-based solid electrolyte and a method for preparing the same according to a third embodiment of the present invention may be the same as the sulfide-based solid electrolyte and the method for preparing the same according to the first embodiment described with reference to FIGS. 1 to 4. However, the third embodiment may be different from the first embodiment in terms of a reactor rotation control scheme.

According to one embodiment, according to the method for preparing the sulfide-based solid electrolyte according to the third embodiment, the unit process (S121 to S126) may be repeatedly performed a plurality of times, in which the rotation of the reactor may be stopped while the unit process (S121 to S126) is performed in an initial stage of repetitions (for example, from first to 10th repetitions among 30 repetitions), and the rotation of the reactor may be performed after the unit process (S121 to S126) is performed. In contrast, the rotation of the reactor may be continuously performed while the unit process (S121 to S126) is performed in a late stage of repetitions (for example, from 11th to 30th repetitions among 30 repetitions). Accordingly, damage to the sulfide-based solid electrolyte 100 may be minimized, and deposition uniformity of the protective film 200 may be improved.

In more detail, in a case of the initial stage of repetitions, taking into account a characteristic (soft characteristic) of the sulfide-based solid electrolyte, the rotation of the reactor may be controlled by the same scheme as described in the first embodiment. However, in a case of the late stage of repetitions, since the deposition of the protective film 200 has been performed at a predetermined level on a surface of the sulfide-based solid electrolyte, inherent problems of the sulfide-based solid electrolyte may be resolved. Accordingly, similar to a general atomic layer deposition process of solid particles, the rotation of the reactor may be continuously performed while the steps S121 to S126 are performed in the late stage of repetitions, so that uniformity of the protective film 200 may be further improved.

The sulfide-based solid electrolytes and the methods for preparing the same according to the embodiments of the present invention have been described above. Hereinafter, specific experimental examples and characteristic evaluation results of the sulfide-based solid electrolytes and the methods for preparing the same according to the embodiments of the present invention will be described.

### Experimental Example 1: Deposition of Metal Oxide on Surface of Sulfide-Based Solid Electrolyte Using ALD

LiPSCl, which is a sulfide-based solid electrolyte, was prepared as Sample 1-1 (Ex 1-1).

Sample 1-2 (Ex 1-2) in which an Al₂O₃ protective film is formed on LiPSCl by using atomic layer deposition was prepared. In more detail, the protective film was formed by the method described with reference to FIGS. 2 and 3, in which trimethylaluminium (TMA) was used as a precursor, and O₃ was used as a reactant. In addition, the protective film was formed at a process temperature of 200° C.

Sample 1-3 (Ex 1-3) in which a ZrO₂ protective film and an Al₂O₃ protective film are formed on LiPSCl by using atomic layer deposition was prepared. In more detail, a first protective film and a second protective film were formed by the method described with reference to FIGS. 6 to 9, in which ZrO₂ was formed as the first protective film, and Al₂O₃ was formed as the second protective film. In addition, tetrakis(ethylmethylamino)zirconium (TEMAZr) was used as a precursor for forming ZrO₂, trimethylaluminium (TMA) was used as a precursor for forming Al₂O₃, and O₃ was used as a reactant. Further, both ZrO₂ and Al₂O₃ were formed at a process temperature of 200° C.

TABLE 1

| Classification | Structure |
|---|---|
| Ex 1-1 | LiPSCl |
| Ex 1-2 | LiPSCl + Al₂O₃ |
| Ex 1-3 | LiPSCl + ZrO₂ + Al₂O₃ |

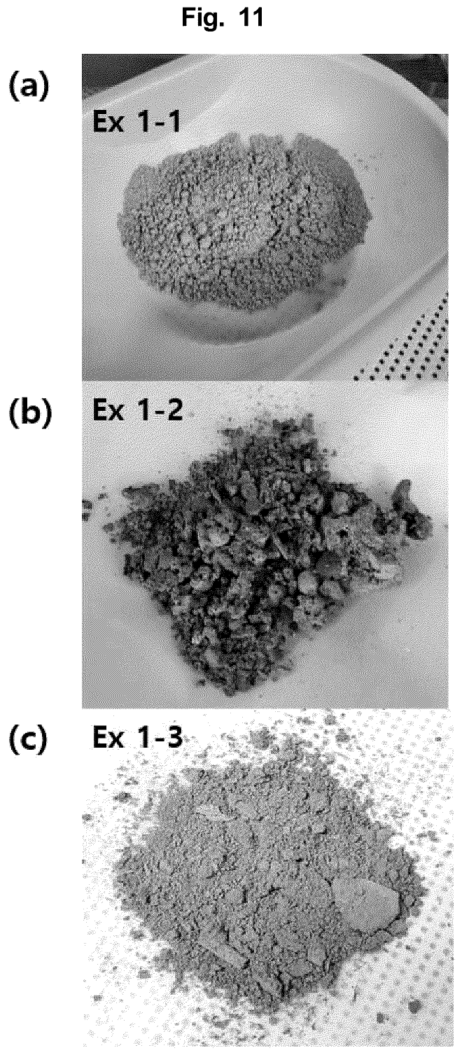

FIG. 11 provides photographs of Samples 1-1 to 1-3.

Referring to (a) in FIG. 11, Sample 1-1 (Ex 1-1) is photographed and shown, referring to (b) in FIG. 11, Sample 1-2 (Ex 1-2) is photographed and shown, and referring to (c) in FIG. 11, Sample 1-3 (Ex 1-3) is photographed and shown.

As shown in FIGS. 11(a) to 11(c), deposition of Al₂O₃ and ZrO₂ was successfully performed on the sulfide-based solid electrolyte by using an atomic layer deposition scheme. In addition, deposition of a single film of Al₂O₃ was successfully performed as shown in FIG. 11(b), and deposition of a double film of ZrO₂+Al₂O₃ was also successfully performed as shown in FIG. 11(c).

### Experimental Example 2: Effect of Type and Deposition Temperature of Precursor in Al₂O₃ Protective Film Formation Process

Sample 2-1 (Ex 2-1) in which an Al₂O₃ protective film is formed on LiPSCl by using the method described with reference to FIGS. 2 and 3 was prepared, in which a DMAIP precursor was used, and the protective film was formed at a process temperature of 180° C.

Sample 2-2 (Ex 2-2) in which an Al₂O₃ protective film is formed on LiPSCl by using the method described with reference to FIGS. 2 and 3 was prepared, in which a DMAON precursor was used, and the protective film was formed at a process temperature of 180° C.

Sample 2-3 (Ex 2-3) in which an Al₂O₃ protective film is formed on LiPSCl by using the method described with reference to FIGS. 2 and 3 was prepared, in which a TMA precursor was used, and the protective film was formed at a process temperature of 50° C.

Sample 2-4 (Ex 2-4) in which an Al₂O₃ protective film is formed on LiPSCl by using the method described with reference to FIGS. 2 and 3 was prepared, in which a TMA precursor was used, and the protective film was formed at a process temperature of 50° C.

Samples 2-3 and 2-4 were prepared by using the same precursor and the same process temperature with different reactor rotations in a preparing process. In detail, in Sample 2-3, similar to general solid particles, the reactor was continuously rotated while the steps S121 to S126 are performed. In contrast, in Sample 2-4, similar to the first embodiment, the rotation of the reactor was stopped while the steps S121 to S126 are performed, and the reactor was rotated after the performance of the steps S121 to S126 is terminated.

In addition, in processes of preparing Samples 2-1 to 2-4, the steps S121 to S126 were performed for 10 seconds, 10 seconds, 30 seconds, 10 seconds, 10 seconds, and 30 seconds, respectively, and the steps S121 to S123 were repeatedly performed three times ((S121 (10s)→S122 (10s)→S123 (30s))×3→S124 (10s)→S125 (10s)→S126 (30s)).

TABLE 2

| | Precursor | Deposition |
|---|---|---|
| Classification | Used | Temperature |
| Ex 2-1 | DMAIP | 180° C. |
| Ex 2-2 | DMAON | 180° C. |
| Ex 2-3 | TMA | 50° C. |
| Ex 2-4 | TMA | 50° C. |

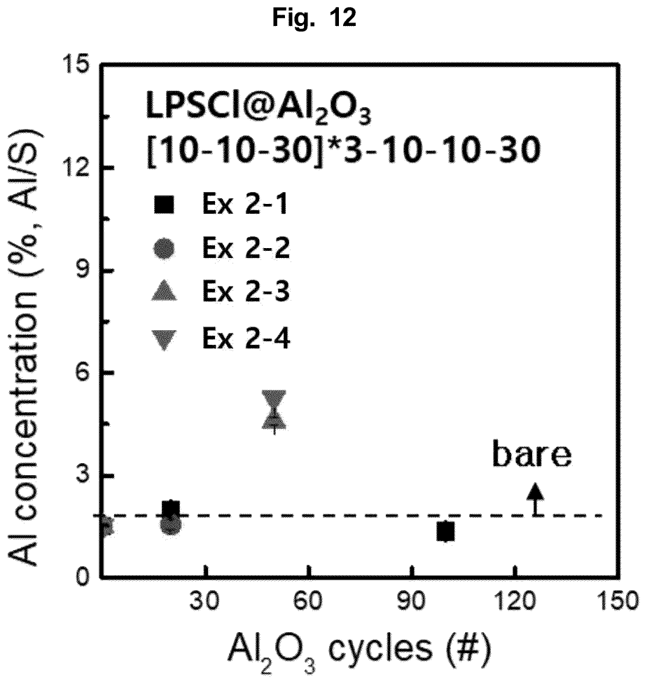

FIG. 12 is a view for describing aluminum content analysis results of Samples 2-1 to 2-4. Referring to FIG. 12, an aluminum concentration (Al concentration, %) according to the number of repetitions of the unit process (Al₂O₃ cycles) was measured and shown for each of Samples 2-1 to 2-4. As shown in FIG. 12, it may be found that when TMA is used as a precursor, deposition of Al₂O₃ is stably performed even with a low-temperature process (50° C.).

### Experimental Example 3: Effect of Reactor Rotation Control in Atomic Layer Deposition Process

LiPSCl, which is a sulfide-based solid electrolyte, was prepared as Sample 3-1 (Ex 3-1).

Samples 3-2 (Ex 3-2) and 3-3 (Ex 3-3) in which ZnO protective films are formed on LiPSCl by using atomic layer deposition were prepared. In more detail, the ZnO protective films were formed by the method described with reference to FIGS. 2 and 3, in which DEZ was used as a precursor, and O₃ was used as a reactant. In addition, the protective films were formed at a process temperature of 180° C.

Samples 3-2 and 3-3 were prepared by using the same precursor and the same process temperature with different reactor rotations in a preparing process. In detail, in Sample 3-2, similar to general solid particles, the reactor was continuously rotated while the steps S121 to S126 are performed. In contrast, in Sample 3-3, similar to the first embodiment, the rotation of the reactor was stopped while the steps S121 to S126 are performed, and the reactor was rotated after the performance of the steps S121 and S126 is terminated.

In addition, in processes of preparing Samples 3-2 and 3-3, the steps S121 to S126 were performed for 5 seconds, 10 seconds, 30 seconds, 10 seconds, 10 seconds, and 30 seconds, respectively, and the steps S121 to S123 were repeatedly performed three times ((S121 (5s)→S122 (10s)→S123 (30s))×3→S124 (10s)→S125 (10s)→S126 (30s)). In addition, the unit process defined as the steps S121 to S126 was repeatedly performed a total of 30 times.

TABLE 3

| | | Reactor Rotation in |
|---|---|---|
| Classification | Structure | ZnO Preparing Process |
| Ex 3-1 | LiPSCl | — |
| Ex 3-2 | LiPSCl + ZnO | continuous rotation during |
| | | S121 to S126 |
| Ex 3-3 | LiPSCl + ZnO | rotation stop during S121 |
| | | to S126; rotation after |
| | | termination of S121 to S126 |

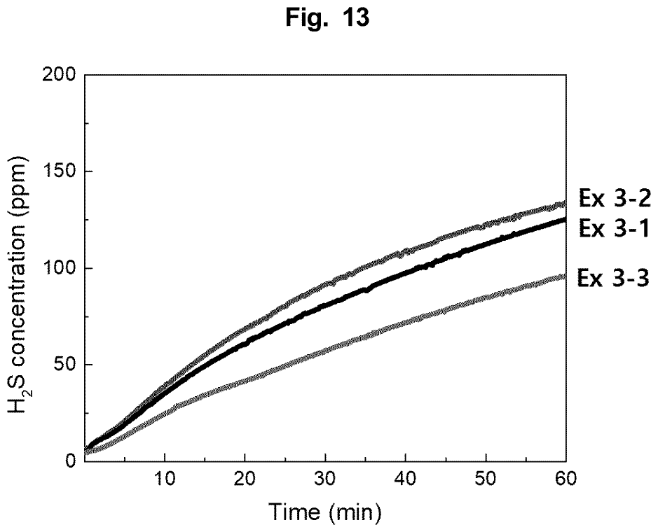

FIG. 13 is a view for comparing hydrogen sulfide generation amounts of Samples 3-1 to 3-3 exposed to an atmospheric environment. Referring to FIG. 13, Samples 3-1 to 3-3 were prepared, each of Samples 3-1 to 3-3 was exposed to an atmospheric environment (50% RF), and a generation amount of hydrogen sulfide (H₂S) generated from each of the samples was measured and shown.

As shown in FIG. 13, in a case of Sample 3-2 (Ex 3-2) in which the rotation of the reactor is not controlled, it may be found that the generation amount of hydrogen sulfide is increased as compared with Sample 3-1 (Ex 3-1), despite the deposition of ZnO. In contrast, in a case of Sample 3-3 (Ex 3-3) in which the rotation of the reactor is controlled, it may be found that the generation amount of hydrogen sulfide is significantly decreased (reduced by about 30%) as compared with Samples 3-1 (Ex 3-1) and 3-2 (Ex 3-2).

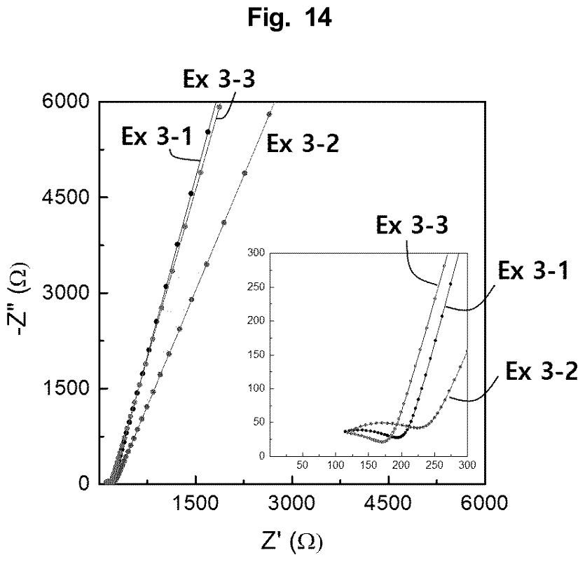

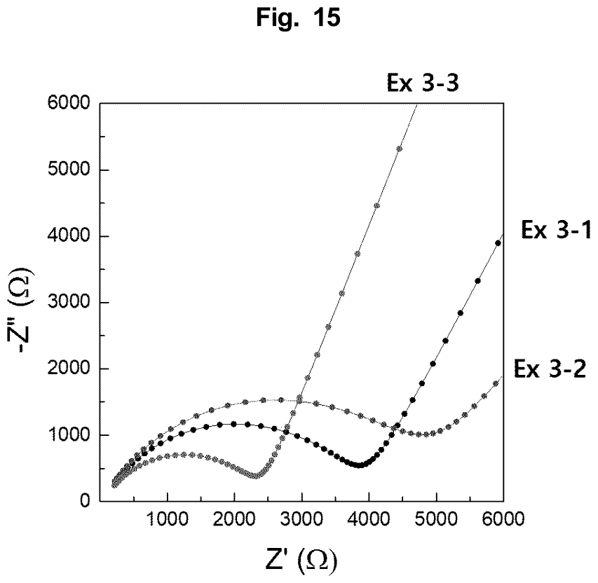

FIGS. 14 and 15 are views showing EIS analysis results of Samples 3-1 to 3-3.

Referring to FIGS. 14 and 15, electrochemical impedance spectroscopy (EIS) analysis results of Samples 3-1 to 3-3 are shown. In more detail, FIG. 14 shows EIS analysis results of Samples 3-1 to 3-3 when Samples 3-1 to 3-3 are not exposed to atmosphere, and FIG. 15 shows EIS analysis results of Samples 3-1 to 3-3 when Samples 3-1 to 3-3 are exposed to the atmosphere. In addition, a resistance, ionic conductivity, and an ionic conductivity retention rate were derived through the EIS analysis results, and the derived values are summarized in Table 4 below.

TABLE 4

| | | | | | Ionic |
|---|---|---|---|---|---|
| | Resistance | | Ionic Conductivity | | Conductivity |
| Classi- | Before | After | Before | After | Retention |
| fication | Exposure | Exposure | Exposure | Exposure | Rate |
| Ex 3-1 | 208 | 3909.6 | 1.05 × | 5.76 × | 5.5% |
| | | | 10⁻³ | 10⁻⁵ | |
| Ex 3-2 | 239.2 | 4766.7 | 9.83 × | 4.65 × | 4.7% |
| | | | 10⁻⁴ | 10⁻⁵ | |
| Ex 3-3 | 187 | 2393.2 | 1.23 × | 9.46 × | 7.7% |
| | | | 10⁻³ | 10⁻⁵ | |

As shown in Table 4, in the case of Sample 3-2 (Ex 3-2) in which the rotation of the reactor is not controlled, it may be found that the ionic conductivity retention rate is decreased as compared with Sample 3-1 (Ex 3-1), despite the deposition of ZnO. In contrast, in the case of Sample 3-3 (Ex 3-3) in which the rotation of the reactor is controlled, it may be found that the ionic conductivity retention rate is high as compared with Samples 3-1 (Ex 3-1) and 3-2 (Ex 3-2). As a result, as shown in Experimental Example 3, it may be found that the rotation control of the reactor (rotation stop during S121 to S126→rotation after termination of S121 to S126) has to be performed in the process of forming the protective film.

### Experimental Example 4: Comparison of Single Protective Film and Double Protective Film

Sample 4-1 (Ex 4-1) in which a ZrO₂ protective film is formed on LiPSCl by using atomic layer deposition was prepared. In more detail, the protective film was formed by the method described with reference to FIGS. 2 and 3, in which TEMAZr was used as a precursor, and O₃ was used as the reactant. In addition, the protective film was formed at a process temperature of 200° C.

In a process of preparing Sample 4-1, the steps S121 to S126 were performed for 20 seconds, 20 seconds, 30 seconds, 10 seconds, 10 seconds, and 30 seconds, respectively, and the steps S121 to S123 were repeatedly performed two times ((S121 (20s)→S122 (20s)→S123 (30s))×2→S124 (10s) S125 (10s)→S126 (30s)). In addition, the unit process defined as the steps S121 to S126 was repeatedly performed a total of 30 times.

Sample 4-2 (Ex 4-2) in which a ZrO₂ protective film and an Al₂O₃ protective film are formed on LiPSCl by using atomic layer deposition was prepared. In more detail, a first protective film and a second protective film were formed by the method described with reference to FIGS. 6 to 9, in which ZrO₂ was formed as the first protective film, and Al₂O₃ was formed as the second protective film. In addition, TEMAZr was used as a precursor for forming ZrO₂, TMA was used as a precursor for forming Al₂O₃, and O₃ was used as a reactant. Further, both ZrO₂ and Al₂O₃ were formed at a process temperature of 200° C.

In a process of preparing Sample 4-2, the steps S221 to S226 were performed for 20 seconds, 20 seconds, 30 seconds, 10 seconds, 10 seconds, and 30 seconds, respectively, and the steps S221 to S223 were repeatedly performed two times ((S221 (20s)→S222 (20s)→S223 (30s))×2→S224 (10s)→S225 (10s)→S226 (30s)). In addition, the first unit process defined as the steps S221 to S226 was repeatedly performed a total of 30 times.

The steps S231 to S236 were performed for 5 seconds, 10 seconds, 30 seconds, 10 seconds, 10 seconds, and 30 seconds, respectively, and the steps S231 to S233 were repeatedly performed three times ((S231 (5s)→S232 (10s)→S233 (30s))×3→S234 (10s)→S235 (10s)→S236 (30s)). In addition, the second unit process defined as the steps S231 to S236 was repeatedly performed a total of 30 times.

TABLE 5

| Classification | Structure |
|---|---|
| Ex 4-1 | LiPSCl + ZrO₂ |
| Ex 4-2 | LiPSCl + ZrO₂ + Al₂O₃ |

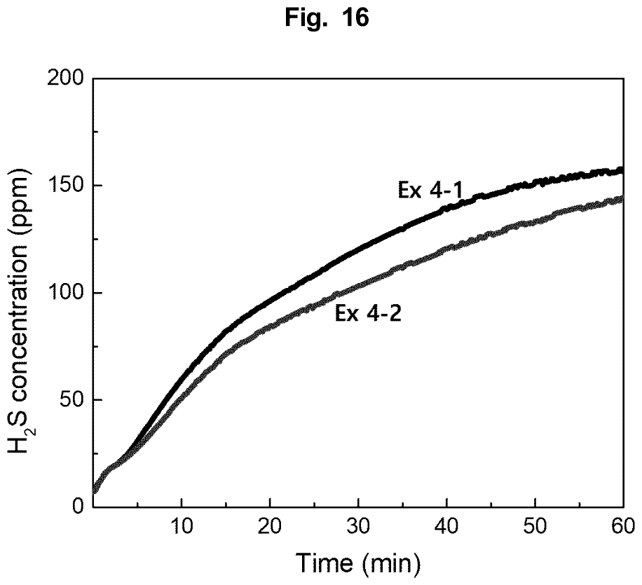

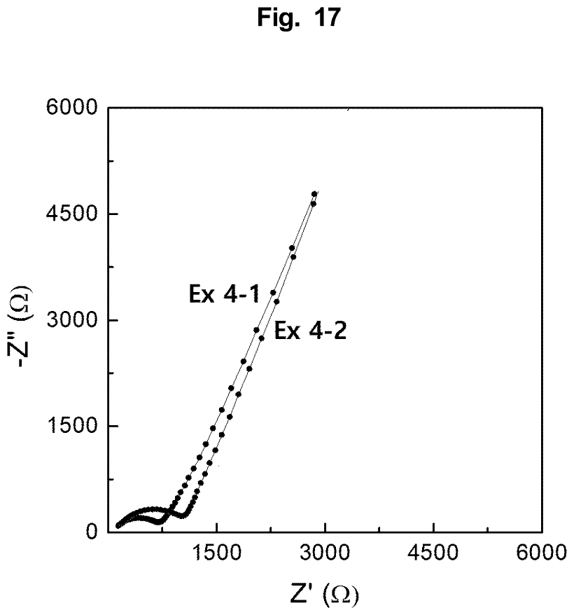

FIG. 16 is a view for comparing hydrogen sulfide generation amounts of Samples 4-1 and 4-2 exposed to an atmospheric environment, and FIG. 17 is a view showing EIS analysis results of Samples 4-1 and 4-2. As shown in FIGS. 16 and 17, it may be found that Sample 4-2 (Ex 4-2) in which a double protective layer is formed exhibits a lower hydrogen sulfide generation amount and higher electrical properties than Sample 4-1 (Ex 4-1) in which a single protective layer is formed. In particular, since severe deterioration occurs when Al₂O₃ is deposited on the sulfide-based solid electrolyte by using TMA at high temperatures (200° C.), it may be found that a relatively stable protective layer such as ZrO₂ may be applied as a passivation so that stable protective film functions (moisture blocking, reduction of hydrogen sulfide generation, maintenance a resistance and ionic conductivity, etc.) may be performed.

Although the exemplary embodiments of the present invention have been described in detail above, the scope of the present invention is not limited to a specific embodiment, and shall be interpreted by the appended claims. In addition, it is to be understood by a person having ordinary skill in the art that various changes and modifications can be made without departing from the scope of the present invention.

### INDUSTRIAL APPLICABILITY

A sulfide-based solid electrolyte and a method for preparing the same according to an embodiment of the present disclosure may be used in all-solid-state secondary batteries and other batteries.

1. A method for preparing a sulfide-based solid electrolyte, the method comprising:
preparing a solid electrolyte including sulfide; and
forming a protective film, which is obtained by reacting a precursor and a reactant, on the solid electrolyte by providing the precursor and the reactant including oxygen on the solid electrolyte.

2. The method of claim 1, wherein the forming of the protective film includes:
a precursor provision step of providing the precursor on the solid electrolyte;
a first dwell step of reacting the precursor with a surface of the solid electrolyte;
a reactant provision step of providing the reactant on the solid electrolyte to which the precursor is provided; and
a second dwell step of reacting the reactant with the surface of the solid electrolyte to which the precursor is provided.

3. The method of claim 2, wherein the forming of the protective film is performed in a reactor that rotates, in which:
the rotation of the reactor is stopped while the precursor provision step, the first dwell step, the reactant provision step, and the second dwell step are performed; and
the rotation of the reactor is performed after the precursor provision step, the first dwell step, the reactant provision step, and the second dwell step are performed.

4. The method of claim 1, wherein the precursor includes one of aluminum (Al), zirconium (Zr), niobium (Nb), titanium (Ti), zinc (Zn), and lithium (Li).

5. The method of claim 1, wherein the reactant includes ozone (O₃).

6. The method of claim 1, wherein the forming of the protective film includes forming a first protective film and forming a second protective film, in which:
the forming of the first protective film includes:
a first precursor provision step of providing a first precursor on the solid electrolyte, and
a first reactant provision step of providing a first reactant on the solid electrolyte to which the first precursor is provided; and
the forming of the second protective film includes:
a second precursor provision step of providing a second precursor on the solid electrolyte, and
a second reactant provision step of providing a second reactant on the solid electrolyte to which the second precursor is provided.

7. The method of claim 6, wherein:
the first precursor and the first reactant react with each other so that the first protective film is formed on the solid electrolyte; and
the second precursor and the second reactant react with each other so that the second protective film is formed on the first protective film.

8. The method of claim 6, wherein:
the first precursor provision step and the first reactant provision step are defined as a first unit process;
the second precursor provision step and the second reactant provision step are defined as a second unit process; and
each of the first unit process and the second unit process is repeatedly performed a plurality of times.

9. The method of claim 6, wherein the first precursor and the second precursor include different metals.

10. The method of claim 1, wherein the solid electrolyte has a powder form.

11. A sulfide-based solid electrolyte comprising:
a core; and
a shell surrounding the core,
wherein the core includes sulfide, and the shell includes a metal oxide.

12. The sulfide-based solid electrolyte of claim 11, wherein the metal oxide includes one of aluminum oxide (Al₂O₃), zirconium oxide (ZrO₂), niobium oxide (NbOₓ, x>0), titanium oxide (TiO₂), zinc oxide (ZnO), LiAlOₓ (x>0), LiZrOₓ (x>0), LiNbOₓ (x>0), and LiTiOₓ (x>0).

13. The sulfide-based solid electrolyte of claim 11, wherein:
the shell includes a first protective film including a first metal oxide and a second protective film including a second metal oxide; and
the first protective film surrounds the core, and the second protective film surrounds the first protective film.

14. The sulfide-based solid electrolyte of claim 13, wherein the first metal oxide and the second metal oxide are different from each other.
